(19) United States
(12) Patent Application Publication
(10) Pub. No.: US 2008/0060824 A1
(43) Pub. Date: Mar. 13, 2008

(54) Adaptor to a fire nozzle that produces a rearward safety spray bubble

(76) Inventor: Charles Howse Partee, Aguila, AZ (US)

Correspondence Address: CHARLES HOWSE PARTEE, BOX 132, AGUILA, AZ, 85320, US

(21) Appl. No.: 11/510,184

(22) Filed: Aug. 24, 2006

(51) Int. Cl. A62C 8/00

(52) U.S. Cl. 169/48; 239/436; 239/504; 239/505; 239/526

(57) ABSTRACT

A cylindrical adapter to a fire nozzle is disclosed which produces not only a forward stream but also at the same time a second rearward directed safety spray cone shaped bubble which encloses the fireman and any persons or property being rescued. This adjustable cone shaped bubble protects the fireman by reducing the radiant heat felt by the fireman as well as dangerous gases. Also is taught a small pipe centered in the cylinder with the purpose to allow a shaft to be inserted therein. This shaft can be used to control the forward stream in future models of the invention.

### CROSS REFERENCE TO RELATED APPLICATIONS

Not Applicable

### STATEMENT REGARDING FEDERALLY SPONSORED RESEARCH OR DEVELOPMENT

Not Applicable

Description of Attached Appendix

Not Applicable

### BACKGROUND OF THE INVENTION

This invention relates generally to the field of firefighting equipment and more specifically to an adaptor to a fire nozzle that produces a rearward cone shaped safety spray bubble.

### BACKGROUND OF THE INVENTION

The standard fire fighting nozzle is coupled to the end of a hose, held by a fireman and directs a stream of water substantially, directly forward at the fire. A number of variations have been disclosed which address the problems of producing various spray patterns and are often referred to as fog nozzles. Fog nozzles for many years have been an important aid in fighting fires by controlling, to some extent, radiant heat, reducing the temperature of a blaze, limiting the amount of oxygen within an enclosed area, and displacing large quantities of combustible gases from a confined area.

Fog nozzles which produce a dispersed spray pattern have a wide variety of structures, but the peripheral jet fire nozzle is most commonly used, because it has the ability to discharge a large amount of water in a straight stream in one position of adjustment and a lessor amount of water in a fog spray in another position of adjustment, all of which are directed in the forward direction.

The inherent problem that exists with all of the known prior art is that the fireman must make a choice between and compromise between the often times more effective straight stream mode which places a large amount of unrestricted water on the fire but which leaves the radiant heat and large quantities of combustible gases un-contained to pose a real danger to the fireman, or the fog mode which more effectively protects the fireman from radiant heat and gases but reduces the amount of water reaching the heart of the blaze.

In the peripheral jet nozzle one common means for producing the rearward fog spray comprises providing a row of equally spaced fixed teeth having a flat face in a circular ring at the discharge end of the nozzle in the path of a conical jet of water issuing forwardly from the interior of the nozzle. However, when the water strikes the face of each tooth, it deflects along the same line as the face of the tooth and the spray pattern consists of a conical row of small spaced jets, creating a gap in the outer conical spray pattern for each tooth. Likewise, there is a gap in the inner spray pattern between each jet of water. The characteristic “fingers” in the spray pattern are objectionable, because they permit radiant heat and gases to pass through the spray pattern. U.S. Pat. No. 4,653,693 addresses the problem of the “fingers” by forming an inner and outer spray pattern to form a single fully filled dispersed forward fog cone having a wide angle of divergence and a circumference free of gaps however, in this mode, the cone of water may provide a better protection for the fire fighter but no forward straight stream mode is provided. Also it can be noted that all the former art makes no effort to reduce in any way the reactive rearward force generated by the forward spray or stream. With larger nozzles this force often requires more than one man to control the hose and nozzle.

It is desirous, then, to provide a dual system which can not only produce forward straight stream but can at the same time produce a backward fog cone to arrest the radiant heat and gases and protect the fireman and persons or property being rescued while at the same time reducing the reactive rearward force generated by the forward stream or fog spray. Furthermore, it can be noted that in a dangerous rescue mode the forward fog can be deployed as well as the rearward cone offering further protection to the fireman and persons or property being rescued.

### BRIEF SUMMARY OF THE INVENTION

In accordance with a preferred embodiment of the invention, there is disclosed an adaptor to a fire nozzle that produces a rearward conical safety spray bubble that completely encloses the fireman and persons or property being rescued thus protecting them from the radiant heat and noxious gasses while at the same time allowing for the use of the normal forward facing stream or fog cone employed by most fire fighting nozzles.

### ADVANTAGES OF THE INVENTION

The primary advantage of the invention is a rearward conical spray bubble that completely encloses the fireman and persons or property being rescued while at the same time allowing the fireman to deploy the normal forward stream at the fire. Another advantage of the invention is that this rearward conical spray bubble reduces the temperature felt by the fireman.

A further advantage of the invention is that this rearward conical spray bubble cleans the air experienced by persons or property inside the bubble.

Yet another advantage of the invention is a generated reactive forward force that helps the fireman control the hose and nozzle.

Other objects and advantages of the present invention will become apparent from the following descriptions, taken in connection with the accompanying drawings and specifications.

### BRIEF DESCRIPTION OF THE DRAWINGS

FIG. 1 is an elevational view of the invention being operated by a fireman displaying a forward stream and the rearward cone shaped safety spray bubble.

FIG. 2 is a cross sectional view of the cylinder showing all the various parts.

FIG. 3 is an end view of the cylinder showing the center support brackets.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DETAILED DESCRIPTION OF THE FIGURES

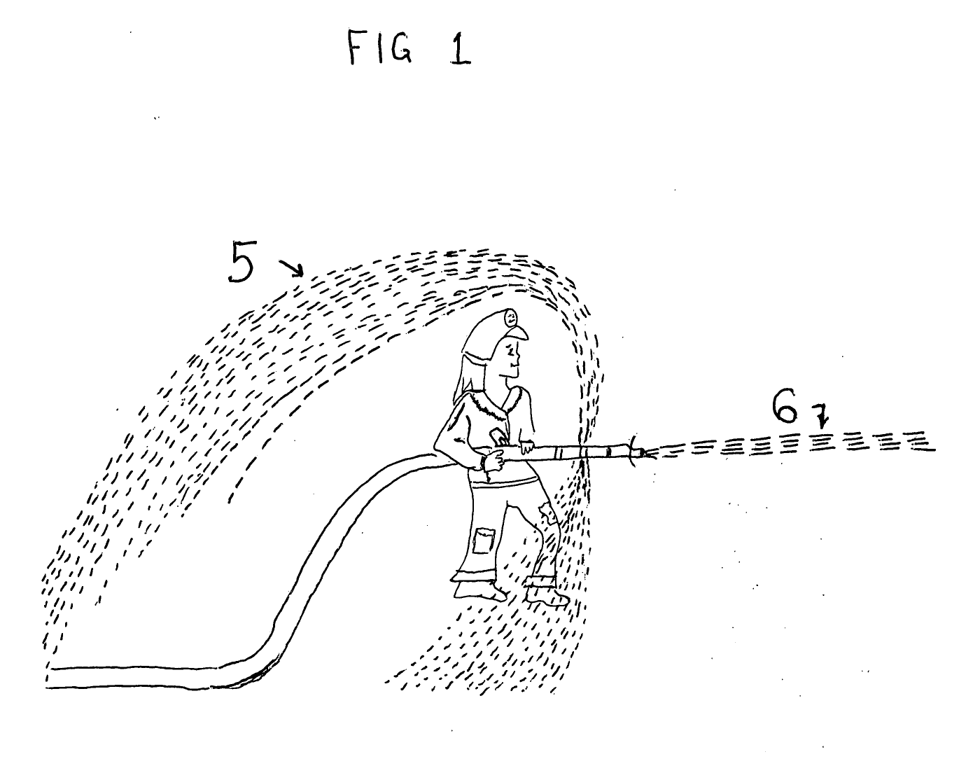

Referring now in detail to the drawings wherein like characters refer to like figures throughout the drawings, FIG. 1 shows a fireman using the invention in the typical mode with the forward stream 6 and the rearward cone shaped safety spray bubble number 5. It can be noted that the fireman is completely enclosed in the bubble and is protected in every direction by the spray and at the same time having very little of the spray actually touching him. This rearward spray bubble also produces a reactive force in the forward direction which acts to reduce the backward reactive force of the forward stream, thus aiding the fireman in physically controlling the hose and nozzle. In all the past art it can be seen that the fireman is deploying only one of the two options available to him all of which are in the forward direction. In this invention both the forward stream 6 or a forward fog cone [not shown] can be deployed at the same time with the rearward cone shaped bubble. With the rear-ward cone deployed the fireman and persons or property inside the bubble are protected against the radiant heat and the noxious gasses normally encountered in a fire.

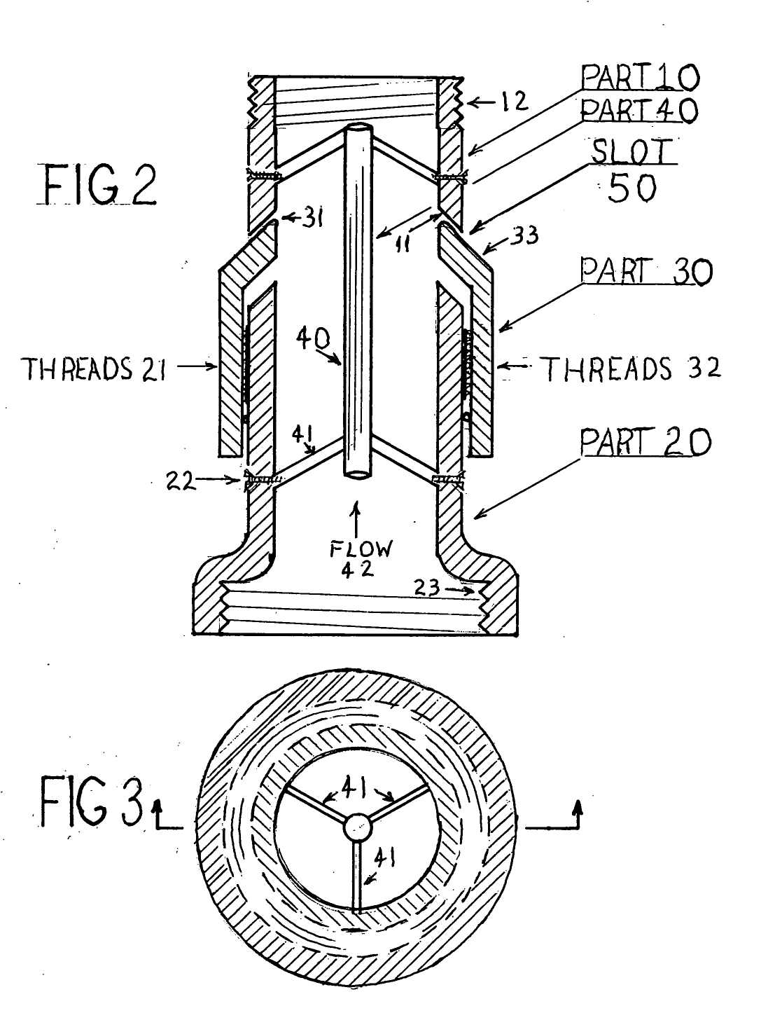

FIG. 2 is a sectional view of the cylinder with male threads 12 sized for a fire nozzle on the forward end part 10 and female threads on the rear end part 20 sized for a fire hose. Liquid, normally water, flows from the rear end part 10 toward the forward end part 10 as depicted by the arrow 42. Said cylinders are supported and held together by part 40 which is a small pipe having support brackets 41 which are mounted internally with screws 22 which facilitate assembly and disassembly.

Part 10 has an angle cut 11 which forms the front half of the slot 50 which produces the rearward spray bubble 5 in FIG. 1. Part 20 is the rearmost part of the cylinder part of the cylinder with female threads 23 sized to fit a hose and having external threads 21 which cooperate with the threads 32 on part 30. Part 30 is a sleeve which rotates axially on part 20 so as to open or close the slot 50 thus controlling the slot 50 thus controlling the width of the rearward cone shaped bubble at the discretion of the fireman. Also part 30 has a slightly rounded tip 31 on the angle cut 33 which acts to increase the speed of the liquid flowing through slot 50 thus aiding the volume, size and shape of the cone shaped bubble 5. FIG. 3 is an end view of the cylinder showing the web brackets 41.

It will now be seen that we have provided a new and unique adapter to a conventional fire nozzle that can fit between the fire hose and any conventional fire nozzle of choice with the adapter producing a controllable rearward cone shaped safety spray bubble controllable at the option of the firefighter which will protect him and persons or property being rescued against the radiant heat and noxious gasses while at the same time using the straight forward stream with the added benefit that the rearward spray helps him in physically controlling the hose.

Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Having described our invention, what we claim as new and desire to secure by Letters Patent is:

1. An adaptor to a fire nozzle that produces a rearward safety spray bubble comprising: a cylinder threaded to accept a fire hose on the rear end and a fire nozzle on the front end with a 360 degree circular slot that is angled to the rear and can be controlled by opening or closing a sleeve which is axially mounted and threaded externally on the cylinder so as to produce a controllable rearward cone shaped spray bubble when water or such liquid is applied under pressure.

2. All the claims in claim with an additional benefit to the fireman in that the rearward spray can be deployed at the same time and in conjunction with the forward stream.

3. All the claims listed in claim 1 and 2 an addition benefit to the fireman in that the rearward spray bubble reduces the temperature felt to persons or property inside the bubble.

4. All the claims of claims 1, 2 and 3 with an additional benefit in that the rearward spray cleans the air thus aiding the breathing of the operator and or persons enclosed in the bubble.

5. All the claims of claims 1, 2, 3, and 4 with an additional benefit to the fire man in that the rearward spray produces a reactive forward force that reduces the rearward force generated by the forward stream thus aiding the fireman in physically controlling the hose and nozzle.

6. All the claims of 1, 2, 3, 4, and 5 with an additional benefit to the function of the invention in that the forwardmost point of the rotational sleeve defined as part 30 in FIG. 2 is slightly rounded which causes an increase in the speed of the liquid passing through the slot thus increasing the size and shape of the cone shaped bubble.

7. All the claims of claims 1, 2, 3, 4, 5 and 6 with an additional claim of the pipe centered in the cylinder that can accept a shaft inserted in the pipe and used to control the forward stream or fog cone in future models of the invention.
